(19) United States
(12) Patent Application Publication
(10) Pub. No.: US 2026/0118188 A1
(43) Pub. Date: Apr. 30, 2026

(54) SYSTEM AND METHOD FOR MEASURING CONDITIONS IN AN ARCJET ENVIRONMENT UTILIZING NON-CATALYTIC CALORIMETER

(71) Applicant: Raytheon Company, Tewksbury, MA (US)

(72) Inventors: Charles J. Bersbach, Tucson, AZ (US); Kirk Christopher Newton, Vail, AZ (US)

(21) Appl. No.: 18/925,838

(22) Filed: Oct. 24, 2024

(51) Int. Cl. G01K 17/08

(52) U.S. Cl. CPC G01K 17/08

(57) ABSTRACT

A non-catalytic calorimeter having: a conductive structure having a sensing surface; a sensor secured to the conductive structure, beneath the sensing surface, the sensor having a sensing element that senses environment conditions adjacent to the sensing surface of the conductive structure; and an electrically insulating coating applied to the sensing surface of the conductive structure.

### BACKGROUND

The embodiments relate to a calorimeter and more specifically to a system and method for measuring conditions in an arcjet environment utilizing non-catalytic calorimeter.

A material utilized as a skin for a device intended for hypersonic flight may be tested in a test facility to determine the material capabilities. The test facility may be an arcjet test facility, which uses a high-power electric arc to heat a gas to high temperatures, creating a plasma flow that mimics the conditions of hypersonic speeds. The plasma flow, which is a high enthalpy flow, is directed at a test material to evaluate the performance characteristics of the test material under harsh conditions. The test facility can simulate various flight conditions, including different velocities, heat fluxes, and pressures. It is desirable to calibrate the system to ensure that the material testing is being adequately performed in a relevant environment. A calorimeter may be utilized for testing conditions within the arcjet test facility by measuring heat flux in a high enthalpy flow. A calorimeter may be formed of a sensing element, such as a thermocouple, embedded in metal, such as a metal block or plate. Catalytic reactions at the surface of the calorimeter may result in skewed measurements of the heat flux in the flow.

### BRIEF DESCRIPTION

Disclosed is a non-catalytic calorimeter including: a conductive structure having a sensing surface; a sensor secured to the conductive structure, beneath the sensing surface, the sensor having a sensing element that senses environment conditions adjacent to the sensing surface of the conductive structure; and an electrically insulating coating applied to the sensing surface of the conductive structure.

In addition to one or more aspects of the non-catalytic calorimeter, or as an alternate, the conductive structure is a metal plate.

In addition to one or more aspects of the non-catalytic calorimeter, or as an alternate, the conductive structure is copper.

In addition to one or more aspects of the non-catalytic calorimeter, or as an alternate, the sensor is a thermocouple.

In addition to one or more aspects of the non-catalytic calorimeter, or as an alternate, the conductive structure is one half of an inch thick and the sensing element is between 50 and 150 thousandths of an inch below the outer surface.

In addition to one or more aspects of the non-catalytic calorimeter, or as an alternate, the coating is a ceramic coating.

In addition to one or more aspects of the non-catalytic calorimeter, or as an alternate, the coating is silicon oxide or silicon nitride.

In addition to one or more aspects of the non-catalytic calorimeter, or as an alternate, the coating has a thickness of between one and one hundred microns.

Disclosed is a system providing a high-enthalpy flow, including: a nozzle that includes a converging inlet segment having a cathode, a diverging outlet segment having an anode, and a constricted neck segment connecting with the inlet segment and the outlet segment, wherein the nozzle generates a high-enthalpy flow; a test chamber coupled to the outlet segment; and a non-catalytic calorimeter within the test chamber, the non-catalytic calorimeter including: a conductive structure having a sensing surface; a sensor secured to the conductive structure, beneath the sensing surface, the sensor having a sensing element that senses environment conditions adjacent to the sensing surface of the conductive structure; and an electrically insulating coating applied to the sensing surface of the conductive structure.

In addition to one or more aspects of the system, or as an alternate, the conductive structure is a metal plate.

In addition to one or more aspects of the system, or as an alternate, the conductive structure is copper.

In addition to one or more aspects of the system, or as an alternate, the sensor is a thermocouple.

In addition to one or more aspects of the system, or as an alternate, the conductive structure is one half of an inch thick and the sensing element is between 50 and 150 thousandths of an inch below the outer surface.

In addition to one or more aspects of the system, or as an alternate, the coating is a ceramic coating.

In addition to one or more aspects of the system, or as an alternate, the coating is silicon oxide or silicon nitride.

In addition to one or more aspects of the system, or as an alternate, the coating has a thickness of between one and one hundred microns.

Disclosed is a method of measuring environment conditions in a test chamber that produces a high enthalpy flow, including: positioning a non-catalytic calorimeter in the test chamber, downstream of a nozzle, wherein the non-catalytic calorimeter includes a conductive structure having a sensing surface; a sensor secured to the conductive structure, beneath the sensing surface, the sensor having a sensing element that senses the environment conditions adjacent to the sensing surface of the conductive structure; and an electrically insulating coating applied to the sensing surface of the conductive structure; generating heat via a heat source in the nozzle, wherein the nozzle includes a converging inlet segment, a diverging outlet segment, and a constricted neck segment connecting with the inlet segment and the outlet segment; generating a flow by directing a gas flow into the nozzle and such that the flow receives heat generated from the heat source, and directing the flow into the test chamber; and measuring the environment conditions in the test chamber with the non-catalytic calorimeter while the flow is directed into the test chamber.

### BRIEF DESCRIPTION OF THE DRAWINGS

The following descriptions should not be considered limiting in any way. With reference to the accompanying drawings, like elements are numbered alike:

FIG. 1 shows an arcjet system configured with a non-catalytic calorimeter utilized to measure environment conditions in a test chamber of the system;

FIG. 2 shows additional details of the non-catalytic calorimeter;

FIG. 3 shows additional details of the non-catalytic, taken along lines 3-3 in FIG. 2; and

FIG. 4 is a flowchart showing a method of measuring environment conditions in the test chamber of the arcjet system utilizing the non-catalytic calorimeter.

### DETAILED DESCRIPTION

A detailed description of one or more embodiments of the disclosed apparatus and method are presented herein by way of exemplification and not limitation with reference to the Figures.

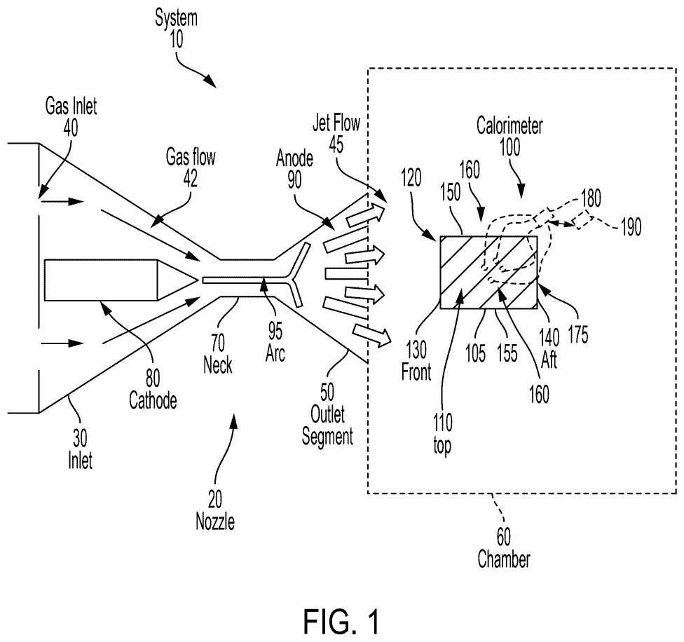

Referring to FIG. 1, an arcjet system 10 is shown. The system 10 includes a nozzle 20 with an inlet segment 30 coupled to a gas supply 40 that provides a gas flow 42, and an outlet segment 50 coupled to a test chamber 60, which may be under vacuum pressure. A neck segment 70 defines a constricted channel that couples the inlet segment 30 to the outlet segment 50. The inlet segment 30 is converging and includes cathode 80. The outlet segment 50 is diverging and includes an anode 90. An electric arc 95 is created between the anode 90 and cathode 80 to add enthalpy to the gas flow 42, significantly heating the gas flow 42. Part of the enthalpy in the flow is converted to kinetic energy using the shape of the nozzle 20. The higher temperatures in the gas flow 42 result in higher specific enthalpy, exhaust velocity and pressure, generating an arcjet flow 45, which can mimic conditions in hypersonic flow around a hypersonic device. That is, the arcjet system 10 may be utilized to test the characteristics of a material that forms the outer shell of a hypersonic device, which may be made of a refractory metal, such as Inconel, molybdenum, niobium, tungsten or titanium, as nonlimiting examples.

Within the chamber 60, a calorimeter 100 is located that will be subject to the arcjet flow 45 exiting the nozzle 20. The non-catalytic calorimeter 100 may be utilized for confirming whether test conditions in the chamber 60 are within acceptable parameters. In other words, the non-catalytic calorimeter 100 may be utilized to calibrate the arcjet system 10.

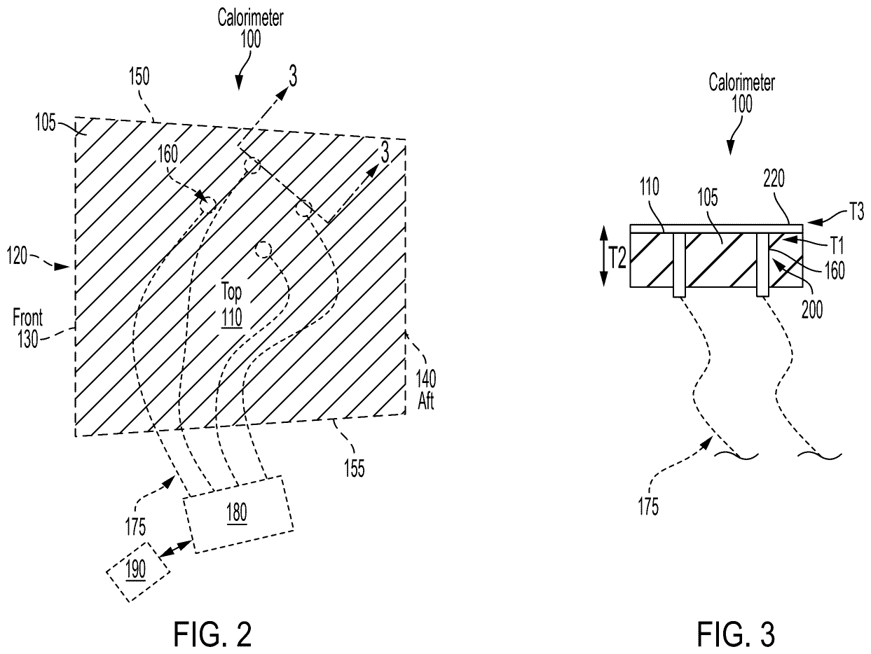

As shown in FIGS. 1 and 2, the calorimeter 100 may include a conductive structure 105 that is a metal plate having a top surface (or sensing surface) 110, a bottom surface 120, a front end 130, an aft end 140, and first and second side ends 150, 155. The conductive structure 105 is shown as having a rectangular surface area forming a block, but this is not intended on limiting the scope of the embodiments. The conductive structure 105 may be oriented in chamber 60 so that the sensing surface 110 faces the outlet segment 50 of the nozzle 20 and is directly subjected to the high enthalpy arcjet flow 45. The conductive structure 105 may be copper, as a non-limiting example.

The non-catalytic calorimeter 100 may include one or more sensors 160 that may extend between the calorimeter 100 and a controller (or processor) 180 via conductors 175. The sensors 160 may be thermocouples and the controller 180 may include or be operationally coupled to a voltmeter 190. The sensors 160 may be utilized to detect heat flux within the chamber 60. With the non-catalytic calorimeter 100, a determination can be made of whether the environment conditions in the chamber 60 of the arcjet system 10 are within targeted parameters. That is, a determination can be made of whether the arcjet flow 45 simulates hypersonic flow conditions experienced by a hypersonic device.

Turning to FIG. 3, the sensors 160 may have tip sensor elements 200 connected to the conductors 175. The elements 200 which may be a combination of dissimilar metals for operation of the thermocouple. The sensor elements 200 may terminate at a first distance T1 of between 50 and 150 thousandths of an inch below the top surface 210 of the conductive structure 105. A second thickness T2 of the conductive structure 105 may be half an inch as a non-limiting example.

According to the embodiments, the sensing surface 110 of the conductive structure 105 is coated with an electrically insulating coating 220. In one embodiment, the coating 220 may be ceramic coating. More specifically, the coating 220 may be silicon oxide or silicon nitride. The coating 220 may have a thickness T3 of between one and one hundred microns. The coating 220 may be sprayed on and optionally etched to the desired thickness.

As indicated, the non-catalytic calorimeter 100 is utilized to detect heat flux from the arcjet flow 45 in the chamber 60. With the coating 220, the non-catalytic calorimeter 100 yields a negligible catalytic impact, and the enthalpy measured in the high enthalpy arcjet flow 45 is a more accurate depiction of the environment conditions of the flow 45 within the chamber 60. That is, the coating 220 removes an exothermic influence from the interactions between the sensing surface 110 of the conductive structure 105 and the arcjet flow 45. That is, an uncoated calorimeter yields a catalytic measurement, as most metals react with the high enthalpy arcjet flow, resulting in heat flux and surface temperature measurements that are higher than in the actual arcjet flow 45, and are thus inaccurate. For example, typical calorimeters made of copper result in higher surface heat flux as the molecular oxygen and nitrogen react on the metal surface. The ceramic coating 220 inhibits the reaction processes and results in a heat flux measurement by the non-catalytic calorimeter 100 that better reflects the true conditions of high-speed environment within the chamber 60. Additionally, because the coating is thin it does not appreciably affect the measurement of the heat flux gage.

The disclosed non-catalytic calorimeter 100 is capable of accurately measuring heating conditions within the chamber 60 and, for example, may be utilized for accurately calibrating the arcjet system 10. The arcjet system 10 may therefore be reliably utilized to test materials intended to travel at hypersonic speeds and be exposed to typical atmospheric conditions at those speeds.

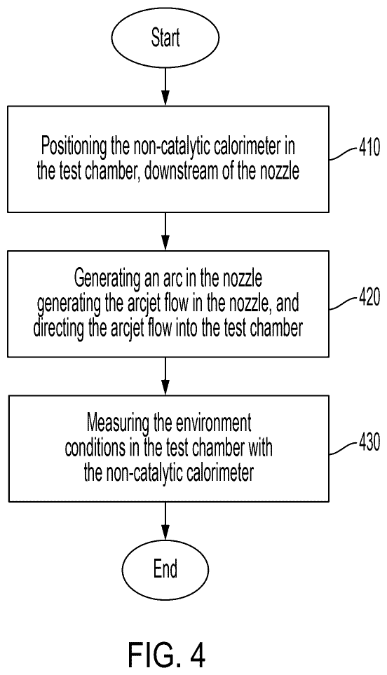

Turning to FIG. 4, a flowchart shows a method of measuring test conditions in an arcjet system 10 utilizing the non-catalytic calorimeter 100.

As shown in block 410, the method includes positioning the non-catalytic calorimeter 100 in the test chamber 60, downstream of the nozzle 20. The non-catalytic calorimeter 100 includes the conductive structure 105 having the sensing surface 110, the sensor 160 secured to the conductive structure 100, beneath the sensing surface 110, the sensor 160 having a sensing element 200 that senses the environment conditions adjacent to the sensing surface 110 of the conductive structure 105, and an electrically insulating coating 220 applied to the sensing surface 110 of the conductive structure 105.

As shown in block 420, the method includes generating an arc 95 in the nozzle 20, generating an arcjet flow 45 by directing a gas flow 42 into the nozzle 20 and over the arc 95, and directing the arcjet flow 45 into the test chamber 60. As indicated, the nozzle 20 includes a converging inlet segment 30 having a cathode 80, a diverging outlet segment 50 having an anode 90, and a constricted neck segment 70 connecting the inlet segment 30 and the outlet segment 50.

As shown in block 430, the method includes measuring the environment conditions in the test chamber 60 with the non-catalytic calorimeter 100 while the arcjet flow 45 is directed into the test chamber 60. As indicated, the coating 220 on the non-catalytic calorimeter 100 will prevent catalytic activity on the sensing surface 110 of the non-catalytic calorimeter 100, providing an accurate reading of heat flux and temperature in the arcjet flow 45.

Reference to an arcjet is not intended on limiting the scope of the embodiments. The disclosed non-catalytic calorimeter is capable of being utilized in any high enthalpy flow environment generated by any means including arc jet, burner rig, plasma jet, high speed flight, etc.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A non-catalytic calorimeter comprising:
a conductive structure having a sensing surface;
a sensor secured to the conductive structure, beneath the sensing surface, the sensor having a sensing element that senses environment conditions adjacent to the sensing surface of the conductive structure; and
an electrically insulating coating applied to the sensing surface of the conductive structure.

2. The non-catalytic calorimeter of claim 1, wherein the conductive structure is a metal plate.

3. The non-catalytic calorimeter of claim 1, wherein the conductive structure is copper.

4. The non-catalytic calorimeter of claim 1, wherein the sensor is a thermocouple.

5. The non-catalytic calorimeter of claim 1, wherein the conductive structure is one half of an inch thick and the sensing element is between 50 and 150 thousandths of an inch below the outer surface.

6. The non-catalytic calorimeter of claim 1, wherein the coating is a ceramic coating.

7. The non-catalytic calorimeter of claim 6, wherein the coating is silicon oxide or silicon nitride.

8. The non-catalytic calorimeter of claim 1, wherein the coating has a thickness of between one and one hundred microns.

9. A system providing a high-enthalpy flow, comprising:
a nozzle that includes a converging inlet segment having a cathode, a diverging outlet segment having an anode, and a constricted neck segment connecting with the inlet segment and the outlet segment, wherein the nozzle generates a high-enthalpy flow;
a test chamber coupled to the outlet segment; and
a non-catalytic calorimeter within the test chamber, the non-catalytic calorimeter including:
a conductive structure having a sensing surface;
a sensor secured to the conductive structure, beneath the sensing surface, the sensor having a sensing element that senses environment conditions adjacent to the sensing surface of the conductive structure; and
an electrically insulating coating applied to the sensing surface of the conductive structure.

10. The system of claim 9, wherein the conductive structure is a metal plate.

11. The system of claim 9, wherein the conductive structure is copper.

12. The system of claim 9, wherein the sensor is a thermocouple.

13. The system of claim 9, wherein the conductive structure is one half of an inch thick and the sensing element is between 50 and 150 thousandths of an inch below the outer surface.

14. The system of claim 9, wherein the coating is a ceramic coating.

15. The system of claim 14, wherein the coating is silicon oxide or silicon nitride.

16. The system of claim 9, wherein the coating has a thickness of between one and one hundred microns.

17. A method of measuring environment conditions in a test chamber that produces a high enthalpy flow, comprising:
positioning a non-catalytic calorimeter in the test chamber, downstream of a nozzle, wherein the non-catalytic calorimeter includes a conductive structure having a sensing surface; a sensor secured to the conductive structure, beneath the sensing surface, the sensor having a sensing element that senses the environment conditions adjacent to the sensing surface of the conductive structure; and an electrically insulating coating applied to the sensing surface of the conductive structure;
generating heat via a heat source in the nozzle, wherein the nozzle includes a converging inlet segment, a diverging outlet segment, and a constricted neck segment connecting with the inlet segment and the outlet segment;
generating a flow by directing a gas flow into the nozzle and such that the flow receives heat generated from the heat source, and directing the flow into the test chamber; and
measuring the environment conditions in the test chamber with the non-catalytic calorimeter while the flow is directed into the test chamber.
